(19) United States
(12) Patent Application Publication
(10) Pub. No.: US 2026/0131721 A1
(43) Pub. Date: May 14, 2026

(54) VEHICLE ACCESSORY BRACKET

(71) Applicant: Church Stewardship Inc., Rifton, NY (US)

(72) Inventors: Barnabas Francis Boller, Cold Brook, NY (US); Daniel Mark Hindley, Cold Brook, NY (US); Gideon Mark Wayne Clement, Rifton, NY (US)

(21) Appl. No.: 19/385,582

(22) Filed: Nov. 11, 2025

Related U.S. Application Data
(60) Provisional application No. 63/719,231, filed on Nov. 12, 2024.

(51) Int. Cl. B60Q 1/04; B60R 3/00

(52) U.S. Cl. CPC B60Q 1/0483; B60R 3/002; B60Q 2900/10

(57) ABSTRACT

An accessory mounting bracket is disclosed for use in attaching an auxiliary light bar to the front recovery hooks of a vehicle, such as a pickup truck or sport utility vehicle, without modifying factory components. The bracket includes a first arm secured to a recovery hook by a clamping mechanism and a second arm connected to the first arm by a pivot that permits angular adjustment of the light bar. The clamping mechanism may include a clamp with an upper plate assembly having a lower cutout shaped to conform to a cross-sectional geometry of a particular recovery hook. A cylindrical spacer may be positioned at the pivot to maintain alignment between the arms. The first arm may include an extended portion forming a non-slip step surface. The bracket provides a universal, adjustable, and non-invasive accessory-mounting solution that preserves full functionality of vehicle sensors and cameras.

### CROSS-REFERENCE

This application claims the benefit of U.S. Provisional Ser. No. 63/719,231 , filed Nov. 12, 2024, under 35 U.S.C. 119(e) which application is incorporated by reference herein in its entirety.

### FIELD

The present disclosure is directed to a mounting system for vehicles, and more particularly to a non-invasive bracket assembly for attaching a vehicle accessory such as a light bar or other accessory to front tow or recovery hooks, especially in late-model pickup trucks.

### BACKGROUND

As modern vehicles have increasingly adopted lightweight materials such as fiberglass and plastic in front bumper assemblies, and as manufacturers have integrated numerous sensors, cameras, and other software-controlled safety and comfort systems, the available options for mounting front-end accessories have become severely limited. For vehicles manufactured in the early 2020s, mounting a front accessory such as a light bar, step, or winch often required cutting or drilling holes in the bumper or replacing entire grille or bumper assemblies at significant cost with versions that included integrated lighting features.

When evaluating available options for late-model pickup trucks the inventors found that mounting any form of light bar was extremely difficult without interfering with factory-installed components. The front bumpers of such vehicles incorporate multiple sensors, while the 360-degree camera systems prevent attachment of accessories in front of or on top of the bumper. Mounting behind the grille is also impractical due to the presence of computer-controlled airflow louvers, fins, and other electronically actuated systems that are integral to the vehicle's safety and efficiency functions.

Existing aftermarket solutions share many of the same deficiencies. Some commercial kits are designed for only a single model or trim level and require drilling into the bumper for installation. Others are incompatible with newer model years because of interference with license plate brackets, automatic intake shutters, and airflow control mechanisms. Certain products marketed for late-model vehicles require permanent modification of factory body components or replacement of the entire bumper assembly at considerable expense.

Currently, most viable aftermarket lighting solutions are designed exclusively for premium or specialized truck models, such as off-road performance variants. These solutions often require the purchase of a complete replacement bumper with an integrated light bar, costing several thousand dollars, or installation of an overhead light bar above the windshield, which can introduce wind noise and aerodynamic drag.

Accordingly, there remains a need for a mounting solution that allows a light bar or other front accessory to be installed on a vehicle without drilling, cutting, or otherwise modifying factory components, while remaining compatible with the vehicle's integrated sensors and camera systems. The present disclosure addresses this need by providing a non-invasive bracket assembly that attaches securely to the vehicle's existing front recovery hooks to serve as a mounting platform for a light bar or other accessories.

### SUMMARY

The present disclosure provides an accessory mounting bracket that attaches to the recovery hooks of a vehicle, allowing installation of accessories such as auxiliary lighting without modifying factory components or obstructing vehicle sensors and cameras. The bracket includes a first arm secured to a recovery hook by a clamping mechanism and a second arm connected to the first arm by a pivot that enables angular adjustment of a mounted light bar. Various embodiments include a cylindrical spacer at the pivot, vehicle-specific clamping plates, and an extended portion with acorn nuts forming a non-slip step surface. The disclosed system offers a versatile, adjustable, and universally adaptable solution for securely mounting light bars, winches, or other accessories to modern vehicles.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a top view of a first embodiment of an accessory bracket according to the present disclosure in a first position of use;

FIG. 2 is a top angled perspective view of the light bar bracket of the first embodiment of the present disclosure in the first position;

FIG. 3 is a side view of the accessory bracket of the first embodiment of the present disclosure in the first position;

FIG. 4 is a front view of the accessory bracket of the first embodiment of the present disclosure in the first position;

FIG. 5 is a top view of the first embodiment of an accessory bracket according to the present disclosure in a second position of use;

FIG. 6 is a top angled perspective view of the accessory bracket of the first embodiment of the present disclosure in the second position;

FIG. 7 is a side view of the accessory bracket of the first embodiment of the present disclosure in the second position;

FIG. 8 is a front view of the accessory bracket of the first embodiment of the present disclosure in the second position;

FIG. 9 is a front view of the accessory bracket of the first embodiment of the present disclosure shown mounted to a vehicle recovery hook;

FIG. 10 is a front perspective view of a second embodiment of the accessory bracket according to the present disclosure in a first assembled position;

FIG. 11 is a front perspective view of an inner arm used in the second embodiment of the accessory bracket according to the present disclosure;

FIG. 12 is a front perspective view of the second embodiment of the accessory bracket according to the present disclosure in a second partially assembled position;

FIG. 13 is a side perspective view of five different clamp members for use in the second embodiment of the accessory bracket;

FIG. 14 is a front view of a light bar connected to two hooks via two light bar brackets of the second embodiment of the present disclosure;

FIG. 15 is a perspective view of a third embodiment of an accessory bracket according to the present disclosure in a first configuration; and

FIG. 16 is a perspective view of the third embodiment of the accessory bracket according to the present disclosure in a second configuration.

### DETAILED DESCRIPTION

In the present disclosure, like reference numbers refer to like elements throughout the drawings, which illustrate various exemplary embodiments of the present disclosure

The present disclosure is directed to an accessory mounting bracket configured to attach to the front recovery hooks of a vehicle, particularly pickup trucks and sport utility vehicles (SUVs). The disclosed bracket provides a practical and reliable means for installing one or more accessories such as auxiliary light bars without requiring modification to the vehicle's bumper, grille, or other factory components.

In many late-model vehicles, including those manufactured by Ford, Chevrolet, GMC, Dodge, and Jeep, available mounting locations for accessories such as light bars are limited by the integration of sensors, cameras, and other electronic systems used for driver-assist or autonomous driving functions, such as adaptive cruise control or collision-avoidance sensing. Conventional mounting approaches often obstruct these systems or require invasive modifications that may void warranties or degrade the vehicle's safety performance.

The accessory bracket described herein overcomes these limitations by utilizing the vehicle's existing recovery hooks as secure attachment points. This configuration enables the installation of lighting or other accessories in a manner that avoids interference with factory sensor arrays and camera fields of view, thereby preserving full functionality of all vehicle safety and automation systems.

The disclosed bracket assembly is designed to be versatile and adjustable so as to accommodate a wide range of vehicle models and recovery hook geometries. In preferred embodiments, the bracket can be mounted to most contemporary pickup trucks and SUVs without the need for permanent alterations. As such, the accessory bracket provides a universal, adaptable, and non-invasive mounting solution for auxiliary lighting systems on vehicles equipped with front recovery hooks.

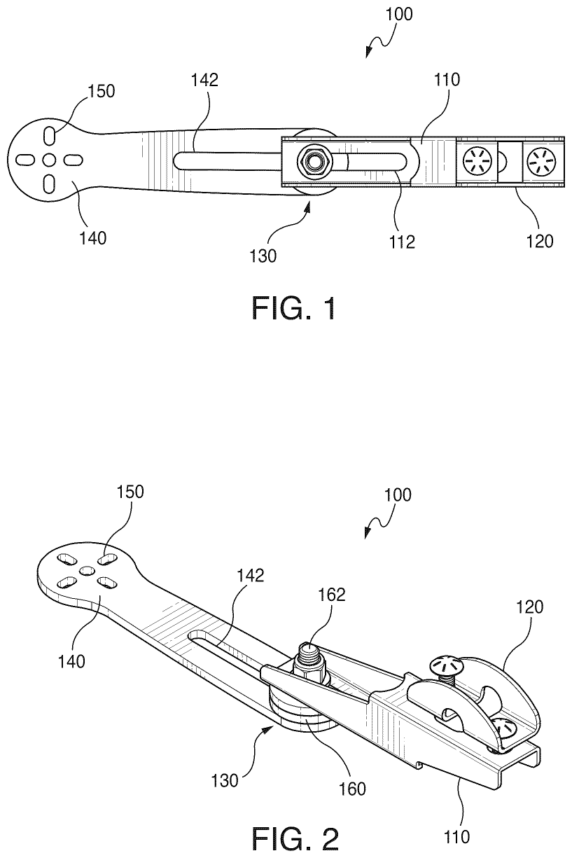

Referring now to FIGS. 1 to 8, a first embodiment of an accessory bracket 100 according to the present disclosure is shown. The accessory bracket 100 comprises a clamping mechanism configured to securely fasten to one of the strongest structural locations on the front of a vehicle—namely, the recovery hooks. Utilization of the recovery hooks as a mounting platform is a key aspect and provides the fundamental distinction of the disclosed bracket over prior mounting systems.

As shown, the accessory bracket 100 includes a first arm 110, which is mounted to the vehicle's recovery hook by means of a clamping mechanism 120, and a pivot 130 that connects the first arm 110 to a second arm 140. The second arm 140 includes one or more apertures 150 formed at a distal end thereof for receiving fasteners used to attach an auxiliary lighting fixture, such as a light bar or pod. The described configuration allows the bracket to accommodate a wide range of light bar sizes, from compact four-inch pods to full-width light bars of approximately fifty inches, by virtue of its adjustability and modular nature.

In the illustrated embodiment, the clamping mechanism 120 may be implemented using a conventional wire-rope clip, a stamped metal clamp assembly, or an equivalent structure that provides a secure mechanical interface to the recovery hook. A conventional wire-rope clip consists of a U-shaped metal saddle, a pair of threaded bolts, and nuts, which, when tightened, clamp the wire rope between the saddle and a base plate to securely fasten the rope ends and prevent slippage. The stamped metal clamp assembly includes apertures allowing it to be bolted to the first arm 110.

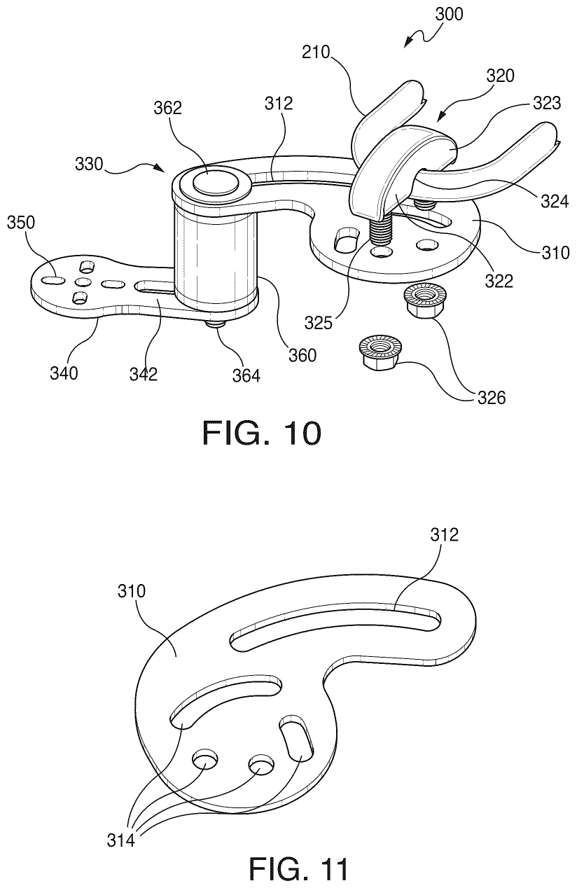

In a further embodiment shown with reference to FIGS. 10 to 13, a clamping mechanism 320 includes a clamp 322 with an upper plate assembly 323 that has a lower cutout 324 shaped to conform to the recovery hook of a particular vehicle model. The upper plate assembly 323 further includes a pair of threaded posts 325 that extend through corresponding apertures 314 in the first arm 310 (FIG. 11), and which are secured thereto by nuts 326 applied from the underside of the first arm 310.

As best shown in FIGS. 1 to 8, the pivot 130 is formed by a bolt-and-nut assembly 162 extending through an aperture 112 in the first arm 110, a spacer 160, and a corresponding aperture 142 in the second arm 140. The aperture 112 and the aperture 142 are preferably elongated or slotted so as to permit both translational and rotational adjustment between the first arm 110 and second arm 140. This configuration enables the installer to select from a variety of angular and positional orientations for the mounted accessory.

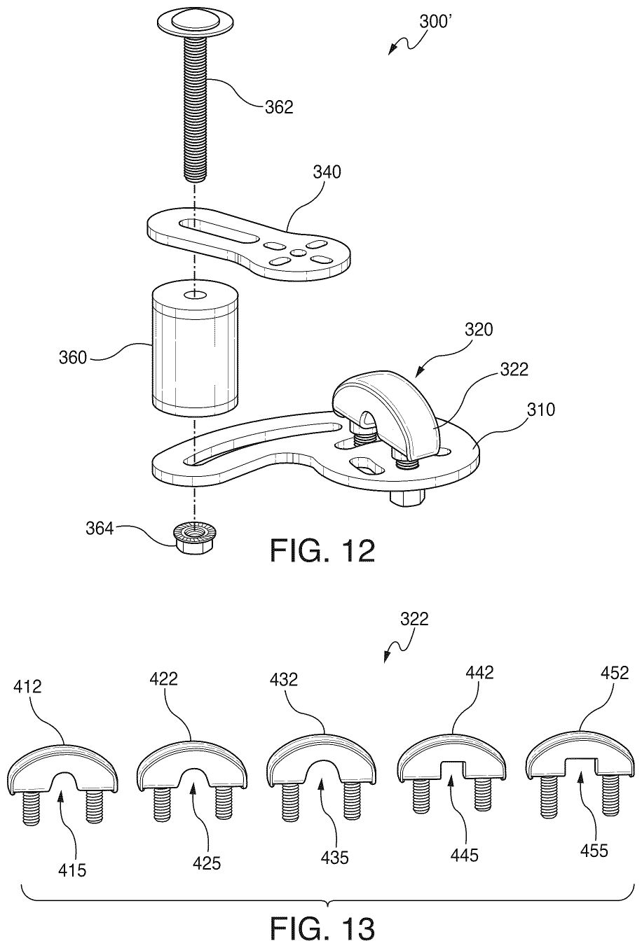

In the embodiment shown, the spacer 160 is represented by a stack of washers positioned between the first arm 110 and second arm 140; however, in an alternative embodiment illustrated in FIG. 12, the spacer 160 may instead be a cylindrical element having a central bore for receiving the bolt of the pivot 130.

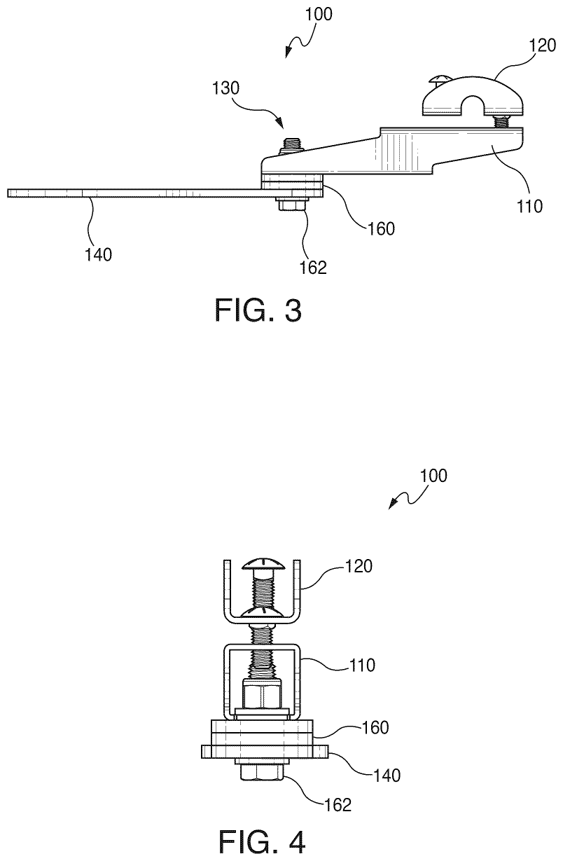

FIGS. 1 to 4 depict the accessory bracket 100 in a first configuration in which the first arm 110 is substantially colinear with the second arm 140 when viewed in plan from above. FIG. 1 shows the bracket in a top plan view, FIG. 2 provides a perspective view from an upper angle, FIG. 3 shows a corresponding side view, and FIG. 4 provides a front elevational view of the same configuration.

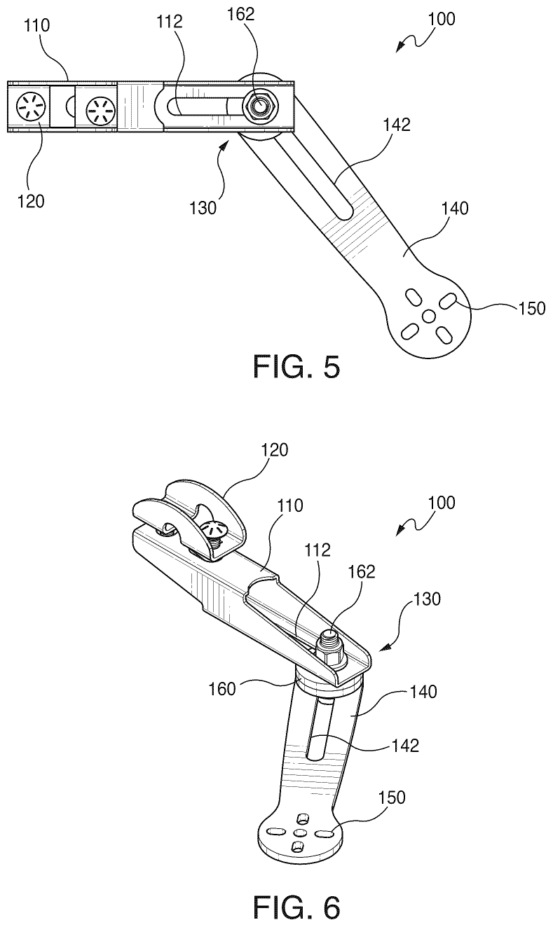

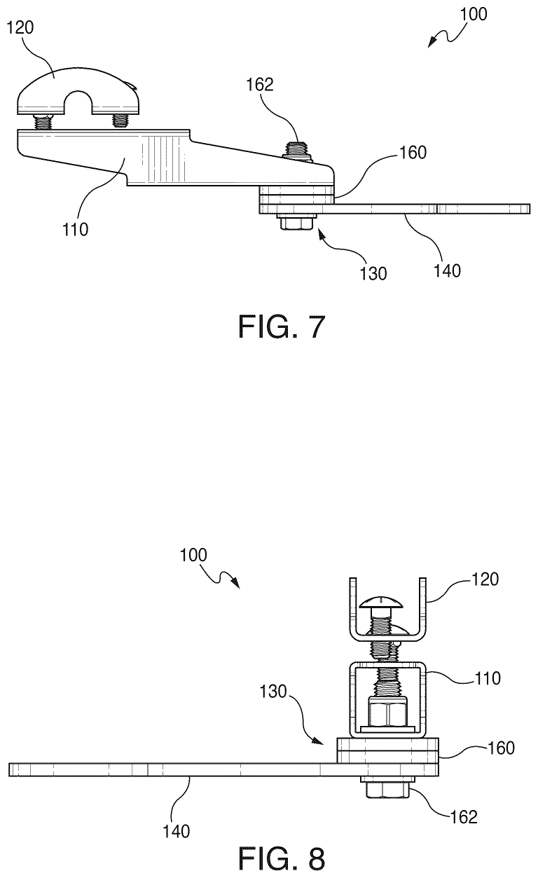

FIGS. 5 to 8 illustrate the accessory bracket 100 in a second configuration in which the first arm 110 is angularly offset relative to the second arm 140 in plan view. FIG. 5 shows the bracket in a top plan view, FIG. 6 provides an angled perspective view, FIG. 7 shows a corresponding side view, and FIG. 8 illustrates a front view of the bracket in the angled configuration. The range of positions illustrated demonstrates the versatility of the pivot mechanism in accommodating a variety of vehicle geometries and desired light-bar orientations.

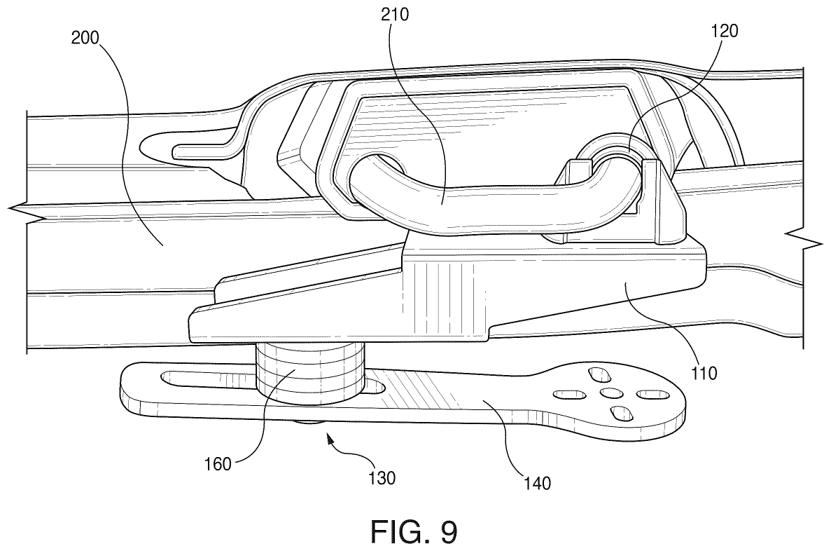

FIG. 9 illustrates the accessory bracket 100 of the present disclosure as mounted to a recovery hook 210 located on the front of a vehicle 200. As shown, the first arm 110 of the accessory bracket 100 is secured to the recovery hook 210 by the clamping mechanism 120, which provides a firm mechanical engagement with the recovery hook 210 without requiring modification of the vehicle 200. The second arm 140 extends forward from the pivot 130, which interconnects the first arm 110 and second arm 140 and allows for angular adjustment of the mounted light bar relative to the vehicle. A spacer 160 formed from four washers is disposed between the first arm 110 and second arm 140 at the pivot connection to maintain alignment and permit smooth rotation. A light bar may be mounted to the distal end of the second arm 140, positioned in front of the vehicle 200 such that the light output is unobstructed while maintaining full functionality of the vehicle's sensors, cameras, and other forward-facing systems.

FIG. 10 illustrates a second embodiment of the accessory bracket 300, which is similar in overall function to the first embodiment described above but differs in structural configuration and proportions. In this embodiment, the accessory bracket 300 includes a first arm 310 and a second arm 340 that are joined together by a pivot 330. The first arm 310 is shorter than the corresponding first arm 110 of the previous embodiment and has a slightly curved profile configured to conform more closely to the contour of the vehicle's front fascia and tow-hook area. The clamping mechanism 320 at a proximal end of the first arm 310 is configured to engage the vehicle's recovery hook 210 in the same general manner as previously described, providing a secure, non-invasive attachment to the front of a vehicle 200.

Unlike the prior embodiment, the pivot 330 of the second embodiment consistently employs a cylindrical spacer 360 positioned between the first arm 310 and the second arm 340. The spacer 360 has a central bore through which a bolt 362 passes to form the pivot connection once secured to a nut 364 via the apertures 312 and 342, thereby maintaining parallel alignment of the arms while permitting controlled angular adjustment of the second arm 340 relative to the first arm 310. The second arm 340 is shorter than the corresponding second arm 140 of the first embodiment, providing a more compact structure suited for installations requiring closer placement of the accessory to the vehicle body via the attachment apertures at a distal end of the second arm 340.

FIG. 11 illustrates the first arm 310 of the accessory bracket 300 in isolation. As shown, the first arm 310 includes an aperture 312 located near a distal end thereof for receiving a fastener that forms part of the pivot 330 connecting the first arm 310 to the second arm 340, as described above. A plurality of apertures 314 are provided at a proximal end of the first arm 310 to enable selective positioning of the clamping mechanism 320 at various mounting locations. This arrangement allows the same first arm 310 to accommodate different recovery hook geometries and vehicle front-end configurations, thereby enhancing the adaptability of the accessory bracket 300 for installation on a wide range of vehicles. The first arm 310 may be slightly curved, as shown, to conform to the front profile of the vehicle and to optimize the alignment of the accessory when the bracket is installed.

FIG. 12 illustrates an alternative arrangement of an accessory bracket 300′ of the embodiment of FIG. 10 showing the alternative relationship between the first arm 310, the second arm 340, and the cylindrical spacer 360. In this view, the first arm 310 is mounted to a lower end of the cylindrical spacer 360, while the second arm 340 is mounted to an upper end of the cylindrical spacer 360. A fastener, such as a bolt 362 and nut 364 combination, extends through the central bore of the cylindrical spacer 360 to form the pivot 330, thereby allowing the second arm 340 to be rotated relative to the first arm 310 while maintaining the two arms in spaced, parallel alignment. The clamping mechanism 320 is shown mounted to the proximal end of the first arm 310 in the same orientation (facing upwards) as in the embodiment of FIG. 10 for securing the bracket assembly to the vehicle's recovery hook 210.

FIG. 13 illustrates a series of alternative embodiments of a clamp 322 configured for use as part of the clamping mechanism 320 of the accessory bracket 300. In the embodiment shown, five representative clamps are depicted and designated respectively as 412, 422, 432, 442, and 452. Each of the clamps 322 includes a corresponding lower cutout—identified respectively as 415, 425, 435, 445, and 455—that is shaped to conform to the cross-sectional geometry of a recovery hook associated with a particular vehicle make or model. The lower cutouts 415 to 455 provide a contoured interface that enhances the precision and stability of the attachment between the plate assembly and the recovery hook. This configuration ensures a more secure mechanical engagement, minimizes lateral movement, and improves vibration resistance during vehicle operation. By providing a family of clamps 412 to 452 with differently shaped lower cutouts 415 to 455, the accessory bracket system can be readily adapted for installation on a wide variety of vehicles while maintaining consistent strength and alignment characteristics. Each clamp 322 further includes threaded posts that will extend through corresponding apertures in the first arm 310, where they are secured by nuts applied from the opposite side of the first arm 310, as previously described.

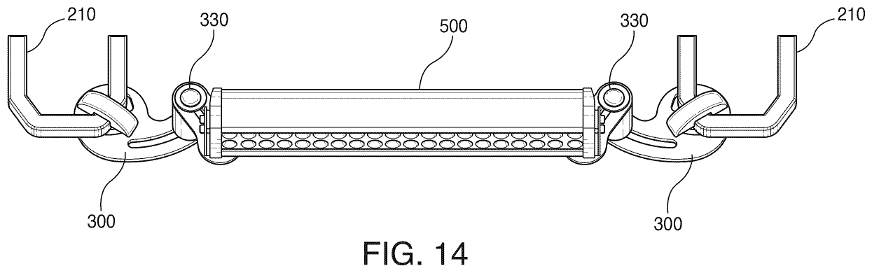

As shown in FIG. 14, an accessory such as a light bar 500 is mounted at the distal end of each second arm 340 of a pair of accessory brackets 300. In typical use, a pair of accessory brackets 300 is employed—one mounted to each of the vehicle's front recovery hooks 210—and the two accessory brackets 300 cooperatively support the opposite ends of the light bar 500. This dual-mount configuration provides a balanced and stable support structure that evenly distributes the load across both recovery hooks, while preserving the ability to fine-tune the light bar's orientation through adjustment at each respective pivot 330.

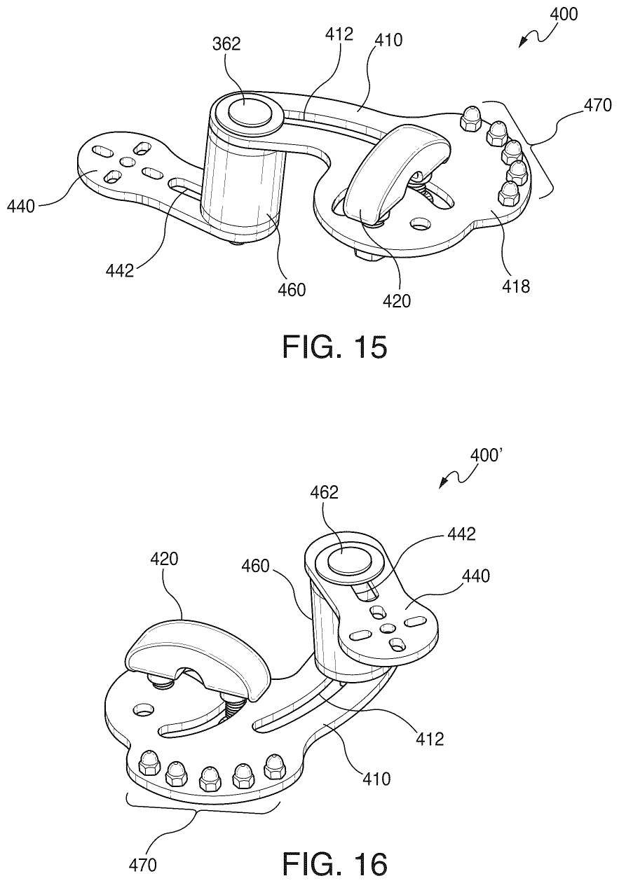

FIG. 15 illustrates a third embodiment of an accessory bracket which corresponds generally to the embodiment shown in FIG. 10 but includes additional structural features that provide enhanced functionality. In this embodiment, the accessory bracket 400 includes a first arm 410 and a second arm 440 interconnected by a pivot 430, with the clamping mechanism 420 securing the first arm 410 to the vehicle's recovery hook 210. The first arm 410 further includes an extended portion 418 that projects laterally outward from the main body of the arm. Mounted on an upper side of the extended portion 418 is a series of acorn nuts 470, for example, five in the illustrated embodiment. The acorn nuts 470 are secured via bolts extending upwardly through corresponding apertures (not shown in FIG. 15) from the lower side of the first arm 410.

The acorn nuts 470 are positioned adjacent to an outer facing edge of the first arm 410, where they collectively form a non-slip step surface that may be used by a user as a foothold when accessing the front portion of the vehicle, such as for cleaning, maintenance, or attaching accessories. In other embodiments, alternate methods of providing a non-slip surface may be used in place of or in addition to the acorn nuts 470. For example, the upper surface of the extended portion 418 may be textured, knurled, coated with a non-slip compound, or fitted with adhesive or molded tread elements. The combination of the extended portion 418 and the selected non-slip surface configuration thus provides dual functionality: maintaining the primary purpose of the accessory bracket 400 as a mounting structure for an accessory, while also offering a practical, integrated step feature that improves vehicle accessibility without interfering with the attachment of the accessory or the operation of vehicle sensors and cameras.

FIG. 16 illustrates a variation of the embodiment shown in FIG. 12, incorporating the additional structural features described with respect to FIG. 15. In this embodiment, the accessory bracket 400′, includes a first arm 410 and a second arm 440 mounted respectively to the lower and upper ends of a cylindrical spacer 460, through which a fastener extends to form the pivot 430. The clamping mechanism 420 is mounted to the proximal end of the first arm 410 in the same orientation as shown in FIG. 12, securing the bracket assembly to the vehicle's recovery hook 210.

As in the FIG. 15 embodiment, the first arm 410 includes an extended portion 418 projecting laterally outward from its main body. A non-lip surface is provided, preferably by way of a plurality of acorn nuts 470—for example, five in the illustrated configuration—mounted along the outer facing edge of the extended portion 418. Each acorn nut 470 is secured on the upper side of the first arm 410 via bolts inserted upwardly through apertures (not shown in FIG. 16) from the lower side of the arm. The acorn nuts 470 collectively define a non-slip step surface that provides a stable foothold for a user, allowing safe and convenient access to the front area of the vehicle for maintenance or accessory installation.

This configuration retains the compact, vertically spaced arm arrangement of FIG. 12 while integrating the functional step feature of FIG. 15. The result is an accessory bracket assembly that combines the robust, vibration-resistant pivot structure of the cylindrical spacer 460 with the added utility of a non-slip stepping surface, without obstructing or impairing any front-facing sensors, cameras, or other vehicle systems.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. An accessory mounting bracket configured for attachment to a recovery hook of a vehicle, comprising:
a first arm having a proximal end and a distal end;
a clamping mechanism disposed at the proximal end of the first arm and configured to secure the first arm to the recovery hook of the vehicle;
a second arm having a proximal end and a distal end;
a pivot connecting the proximal end of the second arm to the distal end of the first arm; and
wherein the distal end of the second arm is configured for attachment of a vehicle accessory.

2. The accessory mounting bracket of claim 1, wherein the pivot comprises a fastener extending through an aperture in the first arm, a spacer, and a corresponding aperture in the second arm.

3. The accessory mounting bracket of claim 2, wherein the spacer comprises a cylindrical post having a central bore through which the fastener extends.

4. The accessory mounting bracket of claim 1, wherein the clamping mechanism comprises a clamp having an upper metal plate assembly having a lower cutout shaped to conform to a cross-sectional geometry of a particular recovery hook.

5. The accessory mounting bracket of claim 4, wherein the clamp includes a pair of threaded posts.

6. The accessory mounting bracket of claim 1, wherein the first arm comprises a plurality of apertures at the proximal end to permit selective positioning of the clamping mechanism.

7. The accessory mounting bracket of claim 1, wherein the first arm and second arm are connected by the pivot such that the second arm is rotatable relative to the first arm to vary an angle of orientation of the vehicle accessory.

8. The accessory mounting bracket of claim 1, wherein the first arm includes an extended portion projecting laterally outward and a plurality of acorn nuts mounted along an outer edge of the extended portion to define a non-slip step surface.

9. The accessory mounting bracket of claim 2, wherein the aperture in the first arm is elongated.

10. The accessory mounting bracket of claim 2, wherein the corresponding aperture in the second arm is elongated.

11. The accessory mounting bracket of claim 1, wherein the second arm has one or more apertures at the distal end for receiving fasteners to secure the vehicle accessory to the second arm.

12. The accessory mounting bracket of claim 1, wherein the clamping mechanism is oriented upwardly relative to the first arm when installed.

13. A vehicle accessory system, comprising:
a vehicle having a pair of front recovery hooks;
a pair of accessory mounting brackets, each secured to a corresponding one of the recovery hooks, each of the pair of accessory mounting brackets comprising:
a first arm having a proximal end and a distal end,
a clamping mechanism disposed at the proximal end of the first arm and configured to secure the first arm to the recovery hook of the vehicle,
a second arm having a proximal end and a distal end,
a pivot connecting the proximal end of the second arm to the distal end of the first arm, and wherein the distal end of the second arm is configured for attachment of an auxiliary lighting fixture; and
a vehicle accessory mounted between the distal ends of the respective second arms of the pair of accessory mounting brackets.

14. The vehicle accessory system of claim 13, wherein each pivot is configured to provide angular adjustment of the vehicle accessory relative to the vehicle.

15. The vehicle accessory system of claim 13, wherein the first arm of each accessory mounting bracket has a curved profile configured to conform to a front fascia of the vehicle.

16. The vehicle accessory system of claim 13, wherein each accessory mounting bracket includes a non-slip step surface.

17. The vehicle accessory system of claim 13, wherein the vehicle accessory is a light bar.

18. The vehicle accessory system of claim 13, wherein the clamping mechanism of each accessory mounting bracket comprises a clamp with an upper plate assembly having a vehicle-specific lower cutout that conforms to a cross-sectional geometry of the recovery hooks of the corresponding vehicle model.

19. A method of installing a vehicle accessory on a vehicle having front recovery hooks, comprising:
providing a pair of accessory mounting brackets, each having a first arm, a second arm, a pivot interconnecting the first and second arms, and a clamping mechanism at a proximal end of the first arm;
securing each clamping mechanism to a respective recovery hook of the vehicle;
mounting a vehicle accessory between distal ends of the second arms of the pair of light bar mounting brackets; and
adjusting the pivot of each accessory mounting bracket to orient the vehicle accessory at a desired angle relative to the vehicle.

20. The method of claim 19, wherein the clamping mechanism comprises a clamp with an upper plate assembly having a vehicle-specific lower cutout that conforms to a cross-sectional geometry of the recovery hooks of the corresponding vehicle model.
